(19) United States
(12) Patent Application Publication
(10) Pub. No.: US 2026/0068934 A1
(43) Pub. Date: Mar. 12, 2026

(54) AEROSOL-GENERATING DEVICE

(71) Applicant: KT&G CORPORATION, Daejeon (KR)

(72) Inventors: Chulho JANG, Buchun-si (KR); Jungho KIM, Seoul (KR); Sangcheol PARK, Suwon-si (KR); Jangwon SEO, Yongin-si (KR); Wonkyeong LEE, Guri-si (KR); Jinchul JUNG, Daejeon (KR)

(73) Assignee: KT&G CORPORATION, Daejeon (KR)

(21) Appl. No.: 19/254,680

(22) Filed: Jun. 30, 2025

(30) Foreign Application Priority Data
Sep. 11, 2024 (KR) 10-2024-0123734
Nov. 19, 2024 (KR) 10-2024-0164671

(51) Int. Cl. A24F 40/46; A24F 40/20; A24F 40/51; A24F 40/57; A24F 40/65; H05B 6/72; H05B 6/76

(52) U.S. Cl. CPC A24F 40/46; H05B 6/72; H05B 6/76; A24F 40/20; A24F 40/51; A24F 40/57; A24F 40/65

(57) ABSTRACT

Disclosed is an aerosol-generating device including a body and a radiating unit disposed in the body and formed to provide an insertion space accommodating an aerosol-generating article therein. The radiating unit includes a sheet elongated in a longitudinal direction, an antenna surrounding the insertion space, the antenna being configured to emit microwaves for dielectrically heating the aerosol-generating article, and a shielding portion surrounding the antenna, the shielding portion being configured to prevent the microwaves from being emitted out of the radiating unit. The radiating unit is configured such that the antenna and the shielding portion are disposed spaced apart from each other on the sheet in the longitudinal direction of the sheet and the sheet is rolled in the longitudinal direction.

### CROSS-REFERENCE TO RELATED APPLICATION

This application claims priority from Korean Patent Applications No. 10-2024-0123734, filed on Sep. 11, 2024, and No. 10-2024-0164671, filed on Nov. 19, 2024, in the Korean Intellectual Property Office, the disclosure of which is incorporated herein by reference in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance through an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

An aerosol-generating device for heating an aerosol-generating substance by dielectric heating includes a radiating unit configured to radiate microwaves. In order to prevent microwaves radiated from the radiating unit from leaking to the outside of the device, the aerosol-generating device may include a microwave-shielding structure.

In this case, there is a problem in that the size or volume of the device increases due to the microwave-shielding structure. In addition, there is a problem in that the structure of the device becomes complicated due to the microwave-shielding structure such that an assembly process of the device becomes complicated.

### SUMMARY OF THE DISCLOSURE

It is an object of the present disclosure to solve the above and other problems.

It is another object of the present disclosure to provide an aerosol-generating device including a radiating unit formed by curling a thin film antenna and a shielding portion disposed on a sheet together with the sheet.

It is another object of the present disclosure to provide an aerosol-generating device including a shielding portion surrounding the outside of an antenna and at least one insulating layer disposed between the shielding portion and the antenna.

It is another object of the present disclosure to provide an aerosol-generating device including at least one protective layer disposed inside an antenna and configured to surround the inside of the antenna.

It is another object of the present disclosure to provide an aerosol-generating device having a structure in which a sheet surrounds the outside of a shielding portion a plurality of times.

It is another object of the present disclosure to provide an aerosol-generating device including brackets configured to respectively fix the upper end and the lower end of a radiating unit and connected to a shielding portion.

In accordance with an aspect of the present disclosure for accomplishing the above objects, an aerosol-generating device includes a body and a radiating unit disposed in the body and formed to provide an insertion space accommodating an aerosol-generating article therein, wherein the radiating unit includes a sheet elongated in a longitudinal direction, an antenna surrounding the insertion space, the antenna being configured to emit microwaves for dielectrically heating the aerosol-generating article, and a shielding portion surrounding the antenna, the shielding portion being configured to prevent the microwaves from being emitted out of the radiating unit, and wherein the radiating unit is configured such that the antenna and the shielding portion are disposed spaced apart from each other on the sheet in the longitudinal direction of the sheet and the sheet is rolled in the longitudinal direction.

In accordance with at least one of embodiments of the present disclosure, there is provided a radiating unit formed by curling a thin film antenna and a shielding portion disposed on a sheet together with the sheet, whereby it is possible to reduce the size or volume of the radiating unit.

In accordance with at least one of the embodiments of the present disclosure, the shielding portion surrounds the outside of the antenna, and at least one insulating layer is disposed between the shielding portion and the antenna, whereby it is possible to prevent electrical contact between the shielding portion and the antenna and to prevent microwaves radiated from the antenna from being emitted out of the radiating unit.

In accordance with at least one of the embodiments of the present disclosure, at least one protective layer surrounding the inside of the antenna is disposed inside the antenna, whereby it is possible to prevent the antenna from being damaged during the insertion and removal of an aerosol-generating article.

In accordance with at least one of the embodiments of the present disclosure, there is provided a structure in which a sheet surrounds the outside of the shielding portion a plurality of times, whereby it is possible to maximally reduce heat dissipation to the outside of the radiating unit.

In accordance with at least one of the embodiments of the present disclosure, there are provided brackets configured to respectively fix the upper end and the lower end of the radiating unit and connected to the shielding portion, whereby it is possible to secure rigidity of the radiating unit and to prevent microwaves from being emitted out of the radiating unit through the insertion space.

Further scopes of applicability of the present disclosure will become apparent from the following detailed description. However, those skilled in the art may understand that various modifications and changes may be possible within the concept and scope of the present disclosure, and it should be understood that the detailed description and specific embodiments such as preferred embodiments of the present disclosure will be given by way of illustration only.

### BRIEF DESCRIPTION OF THE DRAWINGS

FIG. 1 is a block diagram of an aerosol-generating device according to an embodiment of the present disclosure;

FIG. 2 is a view showing the aerosol-generating device according to the embodiment of the present disclosure;

FIG. 3 is an exploded perspective view of a radiating unit according to an embodiment of the present disclosure;

FIG. 4 is a view showing an antenna of the radiating unit according to the embodiment of the present disclosure;

FIG. 5 is a view showing a shielding portion of the radiating unit according to the embodiment of the present disclosure;

FIG. 6 is a view showing an unfolded state of the radiating unit according to the embodiment of the present disclosure when viewed from above;

FIG. 7 is a view showing the unfolded state of the radiating unit according to the embodiment of the present disclosure when viewed from the side;

FIG. 8 is a sectional view of the radiating unit according to the embodiment of the present disclosure when viewed from the side;

FIG. 9 is a sectional view of the radiating unit according to the embodiment of the present disclosure when viewed from above;

FIG. 10 is a view showing the unfolded state of the radiating unit according to the embodiment of the present disclosure; and

FIG. 11 is a sectional view of the radiating unit according to the embodiment of the present disclosure when viewed from the side.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

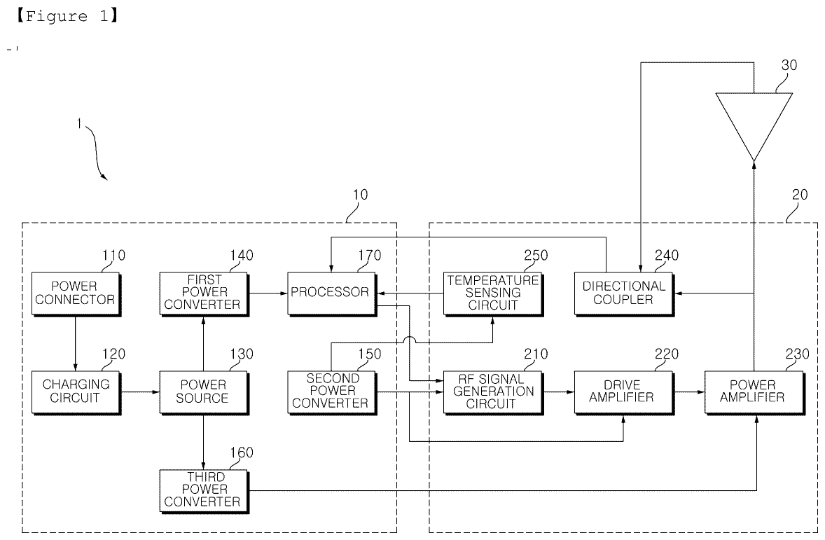

FIG. 1 is a block diagram of an aerosol-generating device 1 according to an embodiment.

In accordance with an embodiment, the aerosol-generating device 1 may include a controller 10, a source unit 20, and a radiating unit 30. The controller 10 may mean a circuit for controlling the basic operation of the aerosol-generating device 1. The source unit 20 may mean a circuit for generating a radio frequency (RF) signal under control of the controller 10. The radiating unit 30 may be an apparatus for radiating the RF signal generated by the source unit 20 to a space into which an aerosol-generating article is inserted (hereinafter, an insertion space) in the form of electromagnetic waves. The radiated electromagnetic waves (e.g., RF signal) may cause charges or ions of a dielectric (e.g., glycerin) contained in the aerosol-generating article to vibrate or rotate, and the aerosol-generating article may be heated as the dielectric is heated by frictional heat generated in the process of the charges or ions vibrating or rotating. In other words, the aerosol-generating device 1 may be an apparatus for generating an aerosol by heating the aerosol-generating article using a dielectric heating method.

In an example, the controller 10 may include a power connector 110, a charging circuit 120, a power source 130, a first power converter 140, a second power converter 150, a third power converter 160, and/or a processor 170. In addition, the source unit 20 may include an RF signal generation circuit 210, a drive amplifier 220, a power amplifier 230, a directional coupler 240, and/or a temperature sensing circuit 250. However, it will be understood by a person having ordinary skill in the art related to the present disclosure that, depending on the design of the aerosol-generating device 1, some of the components shown in FIG. 1 may be omitted or new components may be added.

The power connector 110 may mean a physical connection device that is electrically connected to an electronic device or system external to the aerosol-generating device 1 (e.g., an external power source) and used to transmit and receive power. For example, the power connector 110 may receive power from the external power source, and may transmit the received power to a component that needs to be charged (e.g., the power source 130). The power connector 110 may provide a path for data transmission. The aerosol-generating device 1 may transmit and receive data to and from the external electronic device or system (e.g., smartphone or computer) via the power connector 110. The power connector 110 may include a universal serial bus (USB) power connector and a direct current (DC) power connector. In an example, the power connector 110 may be a USB-C type connector capable of supplying a direct current voltage (DC) of 9 volts (V) at a current of 1 ampere (A), but the present disclosure is not necessarily limited thereto. The power connector 110 may include an interface for wirelessly transmitting and receiving power.

The charging circuit 120 may mean a circuit for charging the power source 130. The charging circuit 120 may charge the power source 130 using power transmitted from the power connector 110. In an example, the charging circuit 120 may be implemented as a charger IC, which is an integrated circuit (IC) that functions to efficiently and safely charge the power source 130. By monitoring the voltage, current, and/or temperature of the power source 130, the charging circuit 120 may monitor the charging state of the power source 130 or optimize the charging process. For example, the charging circuit 120 may detect the state of the power source 130 and provide appropriate charging voltage and current to prevent overcharging or over-discharging.

The power source 130 may supply power for operation of the aerosol-generating device 1. The power source 130 may include one or more rechargeable batteries. The power source 130 may supply power to the radiating unit 30 such that the radiating unit 30 can radiate electromagnetic waves (e.g., RF signal) to the insertion space to heat the aerosol-generating article. Here, the supply of power to the radiating unit 30 may be synonymous with the supply of power to the source unit 20. In addition, the power source 130 may supply power for operation of the processor 170, the RF signal generation circuit 210, the drive amplifier 220, the power amplifier 230, and the temperature sensing circuit 250. In an example, the power source 130 may be, but is not limited to, a lithium polymer (LiPoly) battery. The power source 130 may also be a replaceable (removable) battery (hereinafter, a removable battery). The removable battery may be mounted in a battery compartment provided in the aerosol-generating device 1, or may be removed from the battery compartment. The removable battery may be wired and/or wirelessly charged.

The aerosol-generating device 1 may include a power conversion circuit for converting power supplied from the power source 130 into power (e.g., voltage and/or current) suitable for other components. The power conversion circuit may include at least one of a buck-converter, a buck-boost converter, a boost converter, a Zener diode, and a low-dropout (LDO) regulator. In addition, the power conversion circuit may include a DC/AC converter (e.g., an inverter) as needed.

In an example, the aerosol-generating device 1 may include a first power converter 140, a second power converter 150, and a third power converter 160. The first power converter 140 may be an LDO regulator for supplying suitable power (e.g., DC 3.3 V) to the processor 170, the second power converter 150 may be a buck-boost converter for supplying suitable power (e.g., DC 5 V) to the temperature sensing circuit 250, the RF signal generation circuit 210, and the drive amplifier 220, and the third power converter 160 may be a boost converter for supplying suitable power (e.g., DC 12 V/25 W) to the power amplifier 230.

However, the first power converter 140, the second power converter 150, and the third power converter 160 are not limited to the foregoing examples, and may include other types of power conversion circuits. In addition, although FIG. 1 shows that the aerosol-generating device 1 includes three power converters, the aerosol-generating device 1 may include more than three power converters or less than three power converters. In an example, at least some of the first power converter 140, the second power converter 150, and the third power converter 160 may be integrated into a single power converter.

The processor 170 may control the overall operation of the aerosol-generating device 1. For example, the processor 170 may directly or indirectly control charging and discharging of the power source 130 using the charging circuit 120. In addition, the processor 170 may regulate the voltage and/or current output by the power conversion circuit by regulating the frequency and/or duty ratio of a current pulse input to at least one switching element of the power conversion circuit. The processor 170 may generally control the operation of other components, a description of which will follow, in addition to the components described above.

The processor 170 may be implemented as an array of multiple logic gates or as a combination of a general purpose micro controller unit (MCU) (or, microprocessor) and a memory storing programs that may be executed by the MCU. In addition, it will be understood by a person having ordinary skill in the art to which this embodiment pertains that the processor 170 can be implemented in other forms of hardware.

The RF signal generation circuit 210 may generate an RF signal based on power transmitted from the power source 130 or the second power converter 150. The RF signal may mean a signal having a frequency within a range of 300 MHz to 300 GHz. In an example, the RF signal may have a frequency of 1 GHz to 100 GHz. In addition, the RF signal may have a frequency within an Industrial Scientific and Medical equipment (ISM) band, such as a frequency of 915 MHz, 2.45 GHz, and/or 5.8 GHz.

The RF signal generation circuit 210 may include a voltage controlled oscillator (VCO) for generating RF signals having different frequencies depending on input voltage. The RF signal generation circuit 210 may receive a control signal (e.g., a DC signal) from the processor 170 and generate an RF signal having a frequency corresponding to the received control signal. The processor 170 may store control signals corresponding to desired frequencies in the form of a look-up table, or may calculate a control signal corresponding to a desired frequency in real time through at least one operation.

In an example, the aerosol-generating device 1 may further include a digital to analog (D/A) converter for converting a digital control signal output from the processor 170 into an analog control signal. The RF signal generation circuit 210 may receive an analog control signal and generate an RF signal having a frequency corresponding to the received analog control signal.

The drive amplifier 220 may amplify the RF signal generated by the RF signal generation circuit 210. For example, the drive amplifier 220 may amplify a signal level (e.g., amplitude) of the RF signal to provide a suitable input signal to the component in the next step (e.g., the power amplifier 230). The drive amplifier 220 may minimize distortion of the signal by maintaining high linearity. However, since the drive amplifier 220 is an amplifier focused on increasing the signal level, the drive amplifier may provide relatively low output power.

The power amplifier 230 may amplify power of the RF signal received from the drive amplifier 220. The power amplifier 230 may be an amplifier focused on providing sufficient power to an end output device (e.g., the radiating unit 30). For example, the power amplifier 230 may provide an RF signal with high power to the radiating unit 30 such that the radiating unit 30 can radiate electromagnetic waves to the insertion space to heat the aerosol-generating article. The power amplifier 230 may perform an amplification operation using power received through the third power converter 160 that provides higher power and/or voltage than the second power converter 150.

Each of the drive amplifier 220 and the power amplifier 230 may include a transistor, such as a bipolar junction transistor (BJT) or a field effect transistor (FET), or a vacuum tube. In an example, each of the drive amplifier 220 and power amplifier 230 may be, but is not necessarily limited to, a gallium nitride (GaN) transistor capable of handling high efficiency, high speed, and high voltage. Each of the drive amplifier 220 and power amplifier 230 may include an operational amplifier.

Although the drive amplifier 220 and the power amplifier 230 are shown as separate amplifiers in FIG. 1, the drive amplifier 220 and the power amplifier 230 may be integrated into a single amplifier. In addition, the drive amplifier 220 and/or the power amplifier 230 may include a plurality of amplifiers connected in series, in parallel, and/or in series and parallel.

The radiating unit 30 may include at least one antenna for radiating electromagnetic waves to the space. The at least one antenna may have a size and shape suitable for the size and shape of the aerosol-generating article. For example, if the aerosol-generating article is cylindrical, the at least one antenna may be formed in a tubular shape surrounding the cylindrical aerosol-generating article. Here, the shape of the antenna being tubular may mean that the overall shape of the antenna is tubular. In other words, if the antenna is made of a metal (e.g., SUS) track, this may mean that the overall shape of the track is tubular. The shape of the at least one antenna is not limited to the foregoing examples and may include a variety of shapes, such as a flat plate shape and a curved plate shape.

The radiating unit 30 may radiate electromagnetic waves (e.g., an amplified RF signal or a transmitted RF signal) to the insertion space to heat the aerosol-generating article. In order for the heating efficiency of the aerosol-generating article to be maximized, resonance of the electromagnetic waves must occur in the insertion space. The resonance condition (e.g., resonance frequency) of the insertion space may vary depending on the amount of dielectric contained in the inserted aerosol-generating article. By adjusting a control signal input to the RF signal generation circuit 210, the processor 170 may control the frequency of the RF signal generated by the RF signal generation circuit 210 so as to correspond to or approach the resonance condition of the insertion space. The processor 170 may use the directional coupler 240 to obtain information about the resonance condition of the insertion space.

The directional coupler 240 may mean a passive element having a waveguide structure capable of separating incident and reflected waves. The directional coupler 240 may receive an RF signal transmitted from the power amplifier 230 toward the radiating unit 30 and electromagnetic waves reflected from the insertion space after being radiated by the radiating unit 30. The directional combiner 240 may separate the transmitted RF signal and the reflected electromagnetic waves and transmit the same to the processor 170.

In an example, the aerosol-generating device 1 may further include an analog to digital (A/D) converter for converting an analog output of the directional coupler 240 into a digital output. The A/D converter may be embedded in the processor 170, or may be provided as a separate component external to the processor 170. By monitoring the output of the directional coupler 240, the processor 170 may analyze characteristics (e.g., current, voltage, power, phase, and/or frequency) of the transmitted RF signal and characteristics (e.g., current, voltage, power, phase, and/or frequency) of the reflected electromagnetic waves.

Based on the characteristics of the transmitted RF signal, the processor 170 may determine whether the operation of the source unit 20 is being performed as intended. In addition, the characteristics of the transmitted RF signal may be used in conjunction with the characteristics of the reflected electromagnetic waves to determine the heating efficiency of the source unit 20 or the radiating unit 30. The processor 170 may control the source unit 20 such that the heating efficiency of the source unit 20 or the radiating unit 30 is maximized. For example, the processor 170 may adjust the frequency of the RF signal generated by the RF signal generation circuit 210 such that the power of the reflected electromagnetic waves is minimized. Minimizing the power of the reflected electromagnetic waves may mean that the frequency of the RF signal approaches the resonance condition of the insertion space. The characteristics of the transmitted RF signal may provide a criterion for whether the power of the reflected electromagnetic waves is minimized.

Since resonance of the electromagnetic waves in the insertion space may occur depending on the frequency of the RF signal, the insertion space may be referred to as a resonance unit. At least a part of the insertion space may be surrounded by at least one shielding member to prevent electromagnetic waves from leaking out of the aerosol-generating device 1. In accordance with an embodiment, the insertion space may further include a physical structure for ensuring that resonance occurs within a range controllable by the processor 170. The physical structure may include at least one conductor, and the resonance condition of the insertion space may vary depending on the placement, thickness, and length of the conductor. In addition, the physical structure may include a space for receiving a dielectric with low electromagnetic wave absorbance, independent of the dielectric contained in the aerosol-generating article. The dielectric with low electromagnetic wave absorbance may change the resonant frequency of the entirety of the resonance unit without absorbing energy that must be transmitted to an object to be heated. Accordingly, the resonance condition may be determined to be within a range controllable by the processor 170 even as the resonance unit is miniaturized.

The temperature sensing circuit 250 may be disposed in contact with or adjacent to the components included in the source unit 20 to measure the temperature of the source unit 20. For example, the temperature sensing circuit 250 may be disposed in contact with or adjacent to at least one of the RF signal generation circuit 210, the drive amplifier 220, and the power amplifier 230. In the process of generating and/or amplifying the RF signal, heat may be generated due to limited efficiency, and if excessive, the heat may adversely affect the components included in the source unit 20 or the other components included in the aerosol-generating device 1. The temperature measured by the temperature sensing circuit 250 may be used to prevent the source unit 20 from overheating.

The processor 170 may receive the measured temperature (or a value corresponding to the temperature) from the temperature sensing circuit 250 and may interrupt the operation of the source unit 20 upon determining that the source unit 20 is overheating. For example, the processor 170 may interrupt the operation of the source unit 20 by interrupting the supply of power to the source unit 20 or by sending a control signal. Hereinafter, the term “the supply of power to the source unit 20” will be used to mean controlling whether the source unit 20 operates.

The temperature sensing circuit 250 may include at least one of a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied thereby, but the present disclosure is not necessarily limited thereto.

Meanwhile, the aerosol-generating device 1 may further include other components in addition to the components shown in FIG. 1. For example, the aerosol-generating device 1 may further include a sensor unit, an output unit, an input unit, a communication unit, and a memory. Also, if the aerosol-generating device 1 is a hybrid type device that uses both an aerosol-generating article and a cartridge, the aerosol-generating device 1 may further include a cartridge heater. The cartridge heater may receive power from the power source 130 to heat a medium and/or aerosol-generating substance in the cartridge.

In accordance with an embodiment, the sensor unit may sense the state of the aerosol-generating device 1 or the state in the vicinity of the aerosol-generating device 1 and transmit sensed information to the processor 170. For example, the sensor unit may include a temperature sensor, a puff sensor, an insertion detection sensor, a reuse detection sensor, an overmoisture detection sensor, a cigarette identification sensor, a cartridge detection sensor, a cap detection sensor, and/or a motion detection sensor. Meanwhile, the sensor unit may further include various sensors, such as a liquid level sensor for detecting a liquid level in the cartridge and a flood sensor for detecting flooding of the aerosol-generating device 1.

In accordance with an embodiment, the temperature sensor may detect the temperature of the insertion space or the aerosol-generating article. The temperature sensor may be disposed in contact with or adjacent to the insertion space or the aerosol-generating article to directly measure the temperature of the insertion space or the aerosol-generating article. Alternatively, the temperature sensor may be disposed spaced apart from the insertion space or the aerosol-generating article to indirectly (e.g., contactlessly) measure the temperature of the insertion space or the aerosol-generating article. In an example, the temperature sensor may include an optical temperature sensor (e.g., an infrared temperature sensor).

In accordance with an embodiment, the temperature sensor may sense the temperature of the power source 130. The temperature sensor may be disposed adjacent to the power source 130. For example, the temperature sensor may be attached to one surface of the power source 130 (e.g., a battery), and/or mounted on one surface of a printed circuit board. In an example, the aerosol-generating device 1 may include a protection circuit module (PCM), and the temperature sensor may be disposed adjacent to the power source 130 along with the protection circuit module.

In accordance with an embodiment, the temperature sensor may be disposed in a housing (not shown) of the aerosol-generating device 1 to sense the temperature in the housing (not shown).

In accordance with an embodiment, the puff sensor may detect a user's puff.

In an example, the puff sensor may include a pressure sensor. The pressure sensor may output a signal corresponding to the internal pressure of the aerosol-generating device 1, and the processor 170 may detect the user's puff based on the signal corresponding to the internal pressure. Here, the internal pressure of the aerosol-generating device 1 may correspond to the pressure of an airflow path in which gas flows. The puff sensor may be disposed in the aerosol-generating device 1 so as to correspond to the airflow path in which the gas flows.

In another example, the puff sensor may include a temperature sensor. When a user puffs, a temporary temperature drop may occur in the airflow path, the insertion space, and the aerosol-generating article. The processor 170 may detect the user's puff based on a signal corresponding to the temperature of the airflow path output from the temperature sensor.

In another example, the puff sensor may include both a pressure sensor and a temperature sensor. In this case, the temperature sensor may measure a temperature that is used to calibrate the internal pressure measured by the pressure sensor. In an example, the puff sensor may calibrate a signal corresponding to the internal pressure based on the temperature measured by the temperature sensor and output the calibrated signal. In another example, the puff sensor may output a signal corresponding to the temperature measured by the temperature sensor and a signal corresponding to the internal pressure measured by the puff sensor. In this case, the processor 170 may receive the signals and calibrate the signal corresponding to the internal pressure based on the signal corresponding to the temperature.

In another example, the puff sensor may include a capacitive sensor. In the present disclosure, the capacitive sensor may also be referred to as a cap sensor or a capacitance sensor. When the user puffs, a temperature change and/or the flow of the aerosol in the insertion space may occur, whereby the dielectric constant in the insertion space may change. The processor 170 may detect the user's puff based on a signal corresponding to the dielectric constant of the insertion space output from the capacitive sensor.

The puff sensor is not limited to the examples described above and may be implemented as a variety of sensors for detecting the user's puff.

In accordance with an embodiment, the insertion detection sensor may detect insertion and/or removal of the aerosol-generating article. The insertion detection sensors may be installed in the vicinity of the insertion space.

In an example, the insertion detection sensor may include a capacitive sensor. The capacitive sensor may include at least one conductor, wherein the at least one conductor may be disposed adjacent to the insertion space. When the aerosol-generating article is inserted into or removed from the insertion space, the dielectric constant around the conductor may change. The processor 170 may detect the insertion and/or removal of the aerosol-generating article based on a signal corresponding to the dielectric constant in the insertion space output from the capacitive sensor.

In another example, the insertion detection sensor may include an inductive sensor. The inductive sensor may include at least one coil, wherein the at least one coil may be disposed adjacent to the insertion space. If the aerosol-generating article (e.g., a wrapper of the aerosol-generating article) includes a conductor, insertion or removal of the aerosol-generating article into or from the insertion space may cause a change in magnetic field around the coil in which the current flows. The processor 170 may detect the insertion and/or removal of the aerosol-generating article including the conductor based on the characteristics of the current output from or sensed by the inductive sensor (e.g., the frequency of the alternating current, current value, voltage value, inductance value, and impedance value). Alternatively, the aerosol-generating article (e.g., a medium unit of the aerosol-generating article) may include a susceptor (SUS). Even in this case, a change in magnetic field may occur around the coil based on the insertion or removal of the susceptor into or from the insertion space, and the processor 170 may detect the insertion and/or removal of the aerosol-generating article based on the characteristics of the current in the inductive sensor.

The insertion detection sensor is not limited to the examples described above and may be implemented as a variety of sensors (e.g., a proximity sensor) for detecting insertion and/or removal of the aerosol-generating article. In addition, the insertion detection sensor may include any combination of the above examples. In accordance with an embodiment, the insertion detection sensor may include a switch for detecting pressing by the aerosol-generating article.

In accordance with an embodiment, the reuse detection sensor may detect whether the aerosol-generating article is reused. In an example, the reuse detection sensor may be a color sensor for detecting the color of the aerosol-generating article. When the aerosol-generating article is used by the user, the generated aerosol or heating may cause a change in color of a part of the wrapper surrounding the outside of the aerosol-generating article. The color sensor may output a signal corresponding to optical characteristics (e.g., the wavelength of light) corresponding to the color of the wrapper based on light reflected from the wrapper. The processor 170 may determine that the aerosol-generating article inserted into the insertion space has already been used if a change in color of a part of the wrapper is detected.

In accordance with an embodiment, the overmoisture detection sensor may detect whether the aerosol-generating article is overmoisturized. For example, the overmoisture detection sensor may include a capacitive sensor. The capacitive sensor may include at least one conductor disposed adjacent to the insertion space. The processor 170 may detect whether the aerosol-generating article is overmoisturized based on the level of a signal corresponding to the dielectric constant output from the capacitive sensor. In an example, the processor 170 may determine a level range within which the level of the signal is included based on the look-up table, and determine the amount of moisture in the aerosol-generating article based on the determined level range.

In accordance with an embodiment, the cigarette identification sensor may detect whether the aerosol-generating article is authentic, and/or detect the type of aerosol-generating article.

In an example, the cigarette identification sensor may include an optical sensor for detecting an identification substance (or an identification mark) located on an outer surface (e.g., the wrapper) of the aerosol-generating article. The optical sensor may radiate light toward the identification substance (or the identification mark) on the aerosol-generating article and detect the authenticity and/or type of the aerosol-generating article based on the reflected light. For example, the identification substance may include a substance that emits light having a specific wavelength band based on the radiated light. Based on the wavelength band, the processor 170 may detect the authenticity and/or type of the aerosol-generating article.

In another example, the cigarette identification sensor may include a capacitive sensor. Depending on the type of aerosol-generating article inserted into the insertion space, the dielectric constant in the insertion space may vary. The processor 170 may detect the authenticity and/or type of the aerosol-generating article based on a signal corresponding to the dielectric constant in the insertion space output from the capacitive sensor.

In another example, the cigarette identification sensor may include an inductive sensor. If the wrapper and/or the inside (e.g., the medium unit) of the aerosol-generating article inserted into the insertion space includes a conductor, the characteristics of the current sensed by the inductive sensor (e.g., the frequency of alternating current, current value, voltage value, inductance value, and impedance value) may vary when the aerosol-generating article is inserted into the insertion space depending on the type of aerosol-generating article inserted into the insertion space. Based on the characteristics of the current output from the inductive sensor or sensed by the inductive sensor, the processor 170 may detect the authenticity and/or type of the inserted aerosol-generating article.

The cigarette identification sensor is not limited to the examples described above and may be implemented as a variety of sensors for sensing the authenticity of the aerosol-generating article and/or sensing the type of aerosol-generating article. In addition, the cigarette identification sensor may include any combination of the above examples.

In accordance with an embodiment, the cartridge detection sensor may detect the insertion and/or removal of the cartridge. For example, the cartridge detection sensor may include an inductive sensor, a capacitive sensor, a resistance sensor, a Hall sensor (a Hall IC), and/or an optical sensor.

In accordance with an embodiment, the cap detection sensor can detect mounting and/or removal of a cap. For example, the cap detection sensor may include an inductive sensor, a capacitive sensor, a resistance sensor, a contact sensor, a Hall sensor (a Hall IC), and/or an optical sensor. The cap may include a structure that covers at least a part of the cartridge mounted or inserted into the aerosol-generating device 1 or that covers at least a part of the housing of the aerosol-generating device 1. The cap detection sensor may output a signal corresponding to mounting or removal when the cap is mounted to or removed from the housing, and the processor 170 may detect mounting or removal of the cap based on a signal corresponding to mounting or removal.

In accordance with an embodiment, the motion detection sensor may detect the motion of the aerosol-generating device 1. The motion detection sensor may be implemented as at least one of an acceleration sensor or a gyro sensor.

In accordance with an embodiment, the sensor unit may further include at least one of a humidity sensor, a barometric pressure sensor, a magnetic sensor, a position sensor (a global positioning system (GPS) sensor), or a proximity sensor in addition to the aforementioned sensors. The function of each sensor may be intuitively deduced by those skilled in the art from the designation thereof, and thus a detailed description thereof will be omitted.

In accordance with an embodiment, the output unit may output information about the state of the aerosol-generating device 1. The output unit may include, but is not limited to, a display, a haptic portion, and/or an acoustic output portion. For example, information about the aerosol-generating device 1 may include the charging/discharging state of the power source 130 of the aerosol-generating device 1, the operational state of the source unit 20 or the radiating unit 30, the insertion/removal state of the aerosol-generating article and/or the cartridge, the mounting and/or removal state of the cap, or the state in which the use of the aerosol-generating device 1 is restricted (e.g., detection of an abnormal article). The display may visually provide information about the state of the aerosol-generating device 1 to the user. For example, the display may include a light emitting diode (LED), a liquid crystal display (LCD), or an organic light emitting diode (OLED). The display may be used as an input unit if the display includes a touch pad. The haptic portion may tactually provide information about the state of the aerosol-generating device 1 to the user. For example, the haptic portion may include a vibration motor, a piezoelectric element, or an electrical stimulation device. The acoustic output portion may audibly provide information about the aerosol-generating device 1 to the user. For example, the acoustic output portion may convert an electrical signal into an acoustic signal and output the same to the outside.

In accordance with an embodiment, the input unit may receive information input by the user. For example, the input unit may include a touch panel, a button, a keypad, a dome switch, a jog wheel, or a jog switch.

In accordance with an embodiment, the memory is hardware for storing various data processed in the aerosol-generating device 1, and may store data processed and to be processed by the processor 170. For example, the memory may include at least one of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disc. For example, the memory may store data about the operating time of the aerosol-generating device 1, the maximum number of puffs, the current number of puffs, at least one temperature profile, and a user's smoking pattern.

In accordance with an embodiment, the communication unit may include at least one component for communication with other electronic devices (e.g., a portable electronic device). For example, the communication unit may include a Bluetooth communication unit, a Bluetooth low energy (BLE) communication unit, a near field communication unit, a wireless local area network (WLAN) communication unit, a ZigBee communication unit, an infrared data association (IrDA) communication unit, a Wi-Fi Direct (WFD) communication unit, an ultra-wideband (UWB) communication unit, an adaptive network topology (ANT)+ communication unit, a cellular network communication unit, an Internet communication unit, or a computer network (e.g., LAN or WAN) communication unit.

In accordance with an embodiment, the processor 170 may control the temperature of the insertion space or the aerosol-generating article by controlling the amplification rate of the source unit 20 (e.g., the power amplifier 230). The processor 170 may control the amplification rate of the source unit 20 (e.g., the power amplifier 230) based on the temperature of the insertion space or the aerosol-generating article sensed using the temperature sensor. The processor 170 may control the amplification rate of the source unit 20 (e.g., the power amplifier 230) based on a temperature profile and/or a power profile stored in the memory.

In addition, the processor 170 may control the temperature of the cartridge heater by controlling the supply of power from the power source 130 to the cartridge heater. The processor 170 may control the temperature of the cartridge heater and/or the power supplied to the cartridge heater based on the temperature of the cartridge heater sensed using the temperature sensor. The processor 170 may control the temperature of the cartridge heater and/or the power supplied to the cartridge heater based on the temperature profile and/or the power profile stored in the memory.

In accordance with an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supply of power to the source unit 20 or the cartridge heater based on the temperature of the insertion space, the aerosol-generating article, and/or the cartridge heater exceeding a predetermined limit temperature.

In accordance with an embodiment, the processor 170 may control the supply of power to the source unit 20 or the cartridge heater based on the result sensed by the sensor unit.

In accordance with an embodiment, the processor 170 may control the supply of power to the source unit 20 or the cartridge heater based on the insertion and/or removal of the aerosol-generating article into and/or from the insertion space. For example, the processor 170 may perform control such that power is supplied to the source unit 20 or the cartridge heater upon determining that the aerosol-generating article has been inserted into the insertion space using the insertion detection sensor. The processor 170 may interrupt the supply of power to the source unit 20 or the cartridge heater upon determining that the aerosol-generating article has been removed from the insertion space using the insertion detection sensor. If the temperature of the insertion space or the aerosol-generating article is equal to or greater than the limit temperature or if the change slope of the temperature of the insertion space or the aerosol-generating article is equal to or greater than a set slope, the processor 170 may determine that the aerosol-generating article has been removed from the insertion space.

In accordance with an embodiment, the processor 170 may control the supply time and/or supply amount of power to the source unit 20 or the cartridge heater based on the state of the aerosol-generating article. For example, the processor 170 may increase the supply time of power (e.g., warm-up time) to the source unit 20 or the cartridge heater upon determining that the aerosol-generating article is overmoisturized using the overmoisture detection sensor.

In accordance with an embodiment, the processor 170 may control the supply of power to the source unit 20 or the cartridge heater based on whether the aerosol-generating article is to be reused. For example, the processor 170 may interrupt the supply of power to the source unit 20 or the cartridge heater upon determining that the aerosol-generating article has been used.

In accordance with an embodiment, the processor 170 may control the supply of power to the source unit 20 or the cartridge heater based on coupling and/or removal of the cartridge. For example, the processor 170 may stop the supply of power to the source unit 20 or the cartridge heater, or may perform control such that no power is supplied to the source unit 20 or the cartridge heater, upon determining that the cartridge has been removed using the cartridge detection sensor.

In accordance with an embodiment, the processor 170 may control the supply of power to the source unit 20 or the cartridge heater based on whether the aerosol-generating substance in the cartridge is exhausted. For example, the processor 170 may determine that the aerosol-generating substance in the cartridge has been exhausted upon determining that the temperature of the cartridge heater exceeds the limit temperature while the cartridge heater is warming up (i.e., during a warm-up period). Upon determining that the aerosol-generating substance in the cartridge has been exhausted, the processor 170 may interrupt the supply of power to the source 20 or the cartridge heater.

In accordance with an embodiment, the processor 170 may control the supply of power to the source unit 20 or the cartridge heater based on the availability of the cartridge. For example, the processor 170 may determine that the cartridge is unavailable upon determining that the current number of puffs is equal to or greater than the maximum number of puffs set for the cartridge based on data stored in the memory. Alternatively, the processor 170 may determine that the cartridge is unavailable if the total time the cartridge heater has been heated is equal to or greater than a preset maximum time or the total amount of power supplied to the cartridge heater is equal to or greater than a preset maximum amount of power. In this case, the processor 170 may stop the supply of power to the source unit 20 or the cartridge heater, or may perform control such that no power is supplied to the source unit 20 or the cartridge heater.

In accordance with an embodiment, the processor 170 may control the supply of power to the source unit 20 or the cartridge heater based on the user's puff. For example, the processor 170 may determine whether a puff has occurred and/or the intensity of the puff using the puff sensor. The processor 170 may interrupt the supply of power to the source unit 20 or the cartridge heater when the number of puffs reaches a preset maximum number of puffs and/or when no puffs are sensed for a preset period of time. The processor 170 may control the supply of power to the source unit 20 or the cartridge heater when a puff is detected.

In accordance with an embodiment, the processor 170 may control the supply of power to the source unit 20 or the cartridge heater based on the authenticity and/or type of the aerosol-generating article (or, the cartridge). For example, the processor 170 may detect the authenticity and/or type of the aerosol-generating article using the cigarette identification sensor. In an example, the processor 170 may interrupt the supply of power to the source unit 20 or the cartridge heater if the aerosol-generating article (or the cartridge) is detected to be counterfeit. The processor 170 may control (e.g., initiate) the supply of power to the source unit 20 or the cartridge heater if the aerosol-generating article (or the cartridge) is detected to be genuine. In another example, the processor 170 may control the supply of power to the source unit 20 or the cartridge heater differently depending on the type of the aerosol-generating article (or the cartridge). More specifically, the processor 170 may control the amplification rate of the source unit 20 or the temperature and/or power of the cartridge heater based on a first temperature profile (or a first power profile) if the aerosol-generating article (or the cartridge) is detected to be a first aerosol-generating article (or a first cartridge), and may control the amplification rate of the source unit 20 or the temperature and/or power of the cartridge heater based on a second temperature profile (or a second power profile) if the aerosol-generating article (or the cartridge) is detected to be a second aerosol-generating article (or a second cartridge).

In accordance with an embodiment, the processor 170 may control the output unit based on the result sensed by the sensor unit. For example, the processor 170 may control the output unit to visually, tactually, and/or audibly provide information that the aerosol-generating device 1 is about to shut down when the number of puffs counted using the puff sensor reaches a preset number. For example, the processor 170 may control the output unit to visually, tactually, and/or audibly provide information about the temperature of the insertion space, the aerosol-generating article, or the cartridge heater.

In accordance with an embodiment, the processor 170 may store and update the history of a predetermined event in the memory based on the occurrence of the event. For example, the event may include an operation performed by the aerosol-generating device 1, such as detecting insertion of the aerosol-generating article, initiating heating of the aerosol-generating article, detecting puffing, terminating puffing, detecting overheating, detecting application of overvoltage to the cartridge heater, terminating heating of the aerosol-generating article, turning on/off the aerosol-generating device 1, initiating charging of the power source 130, detecting overcharging of the power source 130, or terminating charging of the power source 130. For example, the history of the event may include the date when the event occurred or log data corresponding to the event. For example, if the predetermined event is detection of insertion of an aerosol-generating article, the log data corresponding to the event may include data about a sensing value of the insertion detection sensor. For example, if the predetermined event is detection of overheating of the cartridge heater, the log data corresponding to the event may include data about the temperature of the cartridge heater, the voltage applied to the cartridge heater, or the current flowing in the cartridge heater.

In accordance with an embodiment, the processor 170 may control the communication unit to form a communication link with an external device, such as a mobile terminal of the user.

In accordance with an embodiment, the processor 170 may lift a restriction on the use of at least one function (e.g., a heating function) of the aerosol-generating device 1 upon receiving data regarding authentication from the external device via the communication link. For example, the data regarding the authentication may include user's birthday, a unique number indicative of the user, or whether the user has completed authentication.

In accordance with an embodiment, the processor 170 may transmit data about the state of the aerosol-generating device 1 (e.g., the remaining capacity of the power source 130 or the operation mode) to the external device via the communication link. The transmitted data may be output through a display of the external device.

In accordance with an embodiment, upon receiving a request to search for the location of the aerosol-generating device 1 from the external device via the communication link, the processor 170 may control the output unit to perform an operation corresponding to the location search. For example, the processor 170 may control the haptic portion to generate vibration, or may control the display to output an object corresponding to the location search and the search termination.

In accordance with an embodiment, the processor 170 may perform firmware update upon receiving firmware data from the external device via the communication link.

In accordance with an embodiment, the processor 170 may transmit data about a sensing value of at least one sensor unit to an external server (not shown) via the communication link, and may receive and store a learning model generated by learning the sensing value through machine learning, such as deep learning, from the server. The processor 170 may perform an operation such as determining a user's inhalation pattern or generating a temperature profile using the learning model received from the server.

Although not shown in FIG. 1, the aerosol-generating device 1 may further include a protection circuit module. The protection circuit module may include at least one switching element and may block a path to the power source 130 in response to overcharging and/or overdischarging of the power source 130.

The aerosol-generating article mentioned in the present disclosure may include at least one aerosol-generating rod (e.g., a medium portion) and at least one filter rod. The radiating unit 30 may be disposed so as to correspond to the at least one aerosol-generating rod, and may be designed differently depending on the arrangement order and/or position of the aerosol-generating rod and the filter rod. The aerosol-generating rod may include at least one of nicotine, an aerosol-generating substance, and an additive. For example, the aerosol-generating substance may include glycerin (e.g., vegetable glycerin (VG)) and/or propylene glycol (PG), and may include various other substances. For example, the additive may include a flavoring agent and/or an organic acid, and may include various other substances. For example, the aerosol-generating rod may include an aerosol-generating substrate (e.g., a sheet) impregnated with a non-tobacco substance (e.g., an aerosol-generating substance and/or nicotine) in a liquid state, and/or a tobacco substance (e.g., tobacco leaf or reconstituted tobacco) in a solid state. The tobacco substance may be included in the aerosol-generating rod in various forms, such as cut tobacco, granule, or powder. In accordance with an embodiment, the additive of the aerosol-generating rod may include a basic substance. Based on the basic substance, the nicotine of the tobacco substance included in the aerosol-generating rod may have a basic pH (e.g., pH 7.0 or higher). In this case, freebase nicotine may be emitted from the aerosol-generating rod even at low temperatures. In accordance with an embodiment, the aerosol-generating rod may include two or more aerosol-generating rods, wherein each of the two or more aerosol-generating rods may include a tobacco substance and/or a non-tobacco substance. Meanwhile, although not shown, the at least one aerosol-generating rod and the at least one filter rod may individually and/or collectively be wrapped by at least one wrapper. In the present disclosure, the aerosol-generating article may be referred to as a stick.

The cartridge mentioned in the present disclosure may contain an aerosol-generating substance in one of a liquid state, a solid state, a gaseous state, or a gel state. The aerosol-generating substance may include a liquid composition. For example, the liquid composition may be a liquid including a tobacco-containing substance, including a volatile tobacco flavor component, or may be a liquid including a non-tobacco substance. Meanwhile, the cartridge may include a reservoir including the aerosol-generating substance and/or a liquid delivery means impregnated with (containing) the aerosol-generating substance. For example, the liquid delivery means may include a wick, such as a cotton fiber, ceramic fiber, glass fiber, or porous ceramic. The cartridge heater may be included in a cartridge in a coil-shaped structure surrounding (or winding) the liquid delivery means or in contact with one side of the liquid delivery means. Alternatively, the cartridge heater may be included in the aerosol-generating device 1, which is separable from the cartridge.

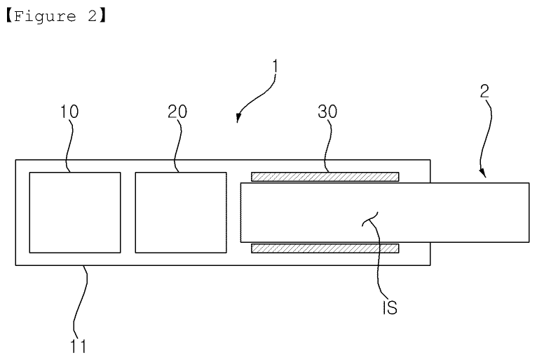

FIG. 2 is a view showing the aerosol-generating device 1 according to the embodiment of the present disclosure.

In accordance with an embodiment, the aerosol-generating device 1 may include a housing 11, a controller 10, a source unit 20, and a radiating unit 30. However, the components included in the aerosol-generating device 1 are not limited to those shown in FIG. 2, and it will be understood by a person having ordinary skill in the art related to the present disclosure that some of the components can be omitted or new components can be added. The aerosol-generating device 1 shown in FIG. 2 may be referred to as an “external heating type” aerosol-generating device, wherein the outside of the aerosol-generating article 2 is heated. In the following drawings, redundant descriptions of FIGS. 1 and 2 will be omitted.

In accordance with an embodiment, the housing 11 may provide an upwardly open space into which the aerosol-generating article 2 is inserted. In the present disclosure, the upwardly open space may be referred to as an insertion space IS. The insertion space IS may be formed so as to be recessed inwardly of the housing 11 to a predetermined depth, such that at least a part of the aerosol-generating article 2 can be inserted thereinto. The depth of the insertion space IS may be equal to or greater than the length of the area of the aerosol-generating article 2 including the aerosol-generating substance and/or the medium. A lower end of the aerosol-generating article 2 may be inserted into the housing 11, and an upper end of the aerosol-generating article 2 may protrude outwardly of the housing 11. The user may inhale the aerosol while holding the upper end of the externally exposed aerosol-generating article 2 in the mouth.

In accordance with an embodiment, the radiating unit 30 may heat the aerosol-generating article 2. Referring to FIG. 2, the radiating unit 30 may have an external heating type structure.

In accordance with an embodiment, the radiating unit 30 may extend upwardly around the insertion space IS into which the aerosol-generating article 2 is inserted. For example, the radiating unit 30 may be disposed so as to surround at least a part of the insertion space IS. In an example, the radiating unit 30 may include a tubular shape (e.g., a cylindrical shape) that includes a hollow therein. The radiating unit 30 may include a shape that includes a hollow therein and encloses the hollow. In this case, the radiating unit 30 may be supported by a polyimide film. The radiating unit 30 may be disposed so as to enclose at least a part of the insertion space IS. The radiating unit 30 may heat the outside of the aerosol-generating article 2 inserted into the hollow.

In accordance with an embodiment, the radiating unit 30 may include a dielectric heating type heater. The aerosol-generating device 1 may include an antenna formed in a tubular shape surrounding the insertion space IS. Meanwhile, an insulating material may be disposed outside the radiating unit 30. This may reduce heat radiated from the radiating unit 30 in a radially outward direction and applied to the outside of the housing 11.

In accordance with an embodiment, the radiating unit 30 may be multiple heaters, and a first antenna and a second antenna may be disposed side by side in a longitudinal direction so as to each enclose at least a part of the insertion space IS. The first antenna and the second antenna may operate as dielectric heating type heaters, and may sequentially or simultaneously radiate electromagnetic waves.

Unlike what is shown in FIG. 2, the antenna of the radiating unit 30 may be wound on a rod-shaped or needle-shaped structure and inserted into the aerosol-generating article 2 through a lower part of the aerosol-generating article 2. In this case, electromagnetic waves radiated from the antenna may propagate from the inside to the outside of the aerosol-generating article 2 and heat the aerosol-generating article 2.

In accordance with an embodiment, the aerosol-generating device 1 may be provided with an airflow channel through which air flows. For example, the housing 11 may include a structure (e.g., a hole) through which air may be introduced into the housing 11 from the outside. The air introduced into the housing 11 may enter the aerosol-generating article 2 through a lower end (i.e., an upstream side) of the aerosol-generating article 2. An aerosol generated by heating of the aerosol-generating article 2 may be inhaled into the oral cavity of the user through an upper end (i.e., a downstream side) of the aerosol-generating article 2 together with the introduced air.

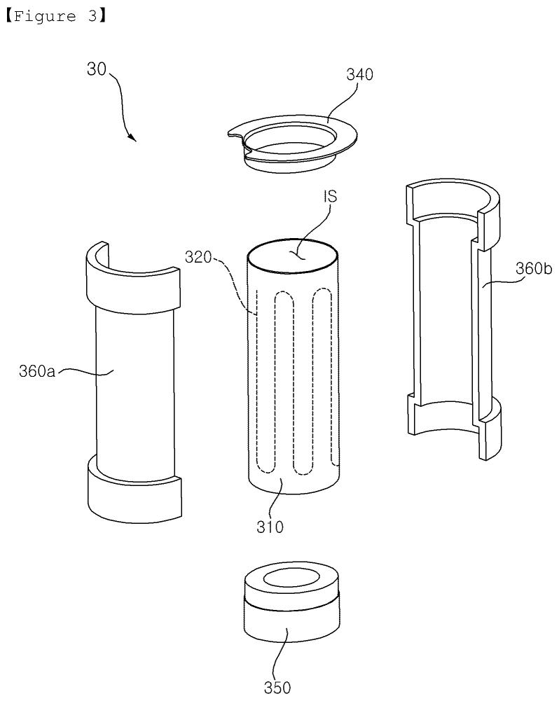

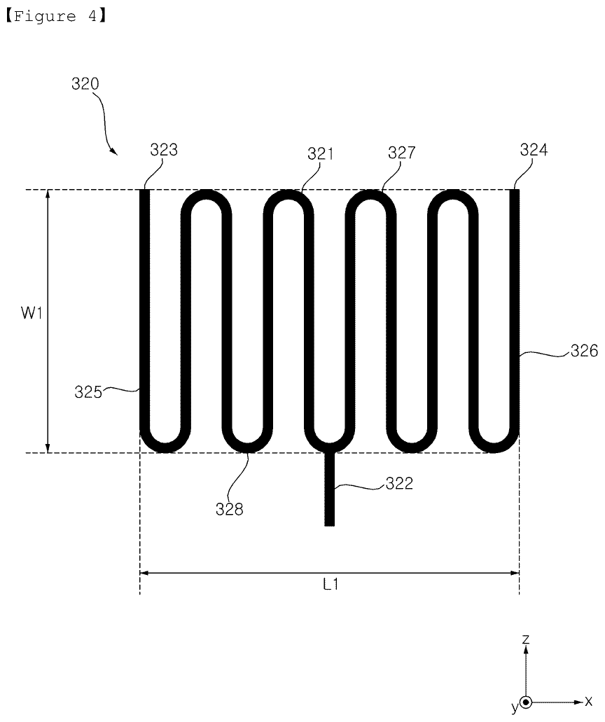

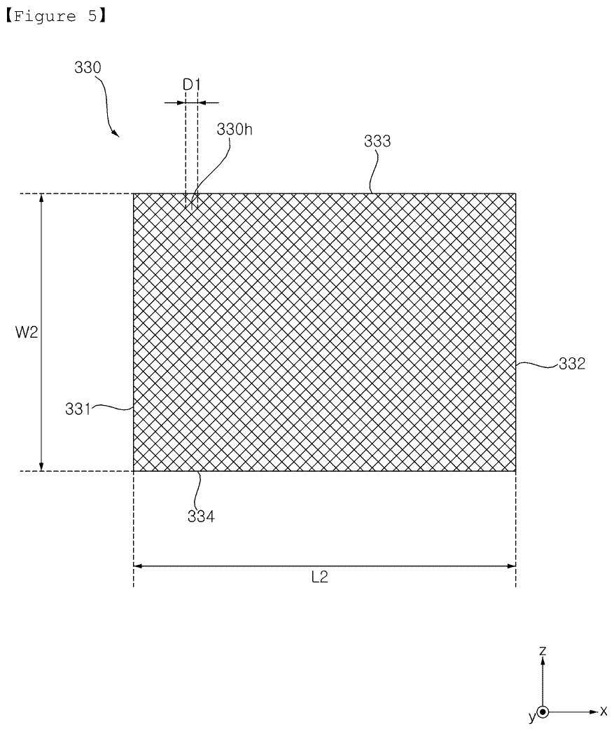

FIG. 3 is an exploded perspective view of a radiating unit according to an embodiment of the present disclosure, FIG. 4 is a view showing an antenna of the radiating unit according to the embodiment of the present disclosure, and FIG. 5 is a view showing a shielding portion of the radiating unit according to the embodiment of the present disclosure.

Referring to FIG. 3, the radiating unit 30 may be disposed in a body 11 (e.g., the housing 11). The radiating unit 30 may be referred to as a heater assembly. The radiating unit 30 may have a tubular or cylindrical shape including a hollow therein. The radiating unit 30 may provide the insertion space IS therein. The radiating unit 30 may heat the aerosol-generating article 2 inserted into the insertion space IS.

The radiating unit 30 may include a sheet 310, an antenna 320, and a shielding portion 330. The antenna 320 and the shielding portion 330 may have a thin and wide shape in the form of a thin film and may be curled together with the sheet 310 to form a hollow structure.

A pair of brackets 340 and 350 may be attached or coupled to the radiating unit 30. The pair of brackets 340 and 350 may be coupled to an opening at one end and an opening at the other end of the hollow radiating unit 30, respectively. The pair of brackets 340 and 350 may be coupled to the radiating unit 30 to support the radiating unit 30.

A casing 360 may be attached or coupled to the radiating unit 30. The casing 360 may include a first casing 360a surrounding a part of a side surface of the radiating unit 30 and a second casing 360b surrounding the remaining part of the side surface of the radiating unit 30. The first casing 360a and the second casing 360b may be coupled to surround the side surface of the radiating unit 30. The first casing 360a and the second casing 360b may be coupled to the brackets 340 and 350 coupled to the radiating unit 30.

The casing 360 and the brackets 340 and 350 may be coupled to receive the radiating unit 30 therein. Thus, the radiating unit 30 may be protected from the outside, and the radiating unit 30 may be rigidly supported, thereby ensuring rigidity of the radiating unit 30.

Referring to FIG. 4, the antenna 320 may have a thin and wide shape in the form of a thin film and may be curled into a round shape to form a hollow structure. The antenna 320 may be formed by etching a metal thin film with a laser. The antenna 320 may radiate an RF signal generated by the source unit 20 (see FIGS. 1 and 2) to the insertion space IS in the form of microwaves. Here, microwaves may mean electromagnetic waves having a frequency of 300 MHz to 300 GHz.

The antenna 320 may include a radiating track 321 and a connection portion 322. The antenna 320 may be a meander antenna extending in both directions.

The radiating track 321 may include at least one track. For example, the radiating track 321 may include two tracks extending in different directions (e.g., a +x direction and a −x direction). Each track may include at least one bent portion, and may have a meanderingly curved shape. The tracks may be symmetrical. The tracks may be connected to each other at one end and form free ends 323 and 324 at the other end.

The connection portion 322 may protrude outward from one side of the radiating track 321. The connection portion 322 may be integrally formed with the radiating track 321. The connection portion 322 may be connected to the source unit 20 and may receive an RF signal from the source unit 20.

The antenna 320 may have a rectangular shape having a length L1 and a width W1. The antenna 320 may be generally rectangular in shape in a flat unfolded state. The length L1 of the antenna 320 may be defined as a distance between one end 325 and the other end 326 of the radiating track 321 in one direction (e.g., an x direction) in the state in which the antenna 320 is unfolded. The width W1 of the antenna 320 may be defined as a distance between one end 327 and the other end 328 of the radiating track 321 in a direction perpendicular to the one direction (e.g., a z direction) in the state in which the antenna 320 is unfolded.

Meanwhile, the shape of the antenna 320 is not limited thereto, and the antenna 320 may include a loop antenna, a planar inverted F antenna (PIFA), a monopole antenna, or a dipole antenna.

Referring to FIG. 5, the shielding portion 330 may have a thin and wide shape in the form of a thin film and may be curled into a round shape to form a hollow structure. The shielding portion 330 may include a metal mesh or a metal sheet having a plurality of holes 330h formed therein. The shielding portion 330 may include a metal material having high electrical conductivity. For example, the shielding portion 330 may contain at least one of copper, silver, or aluminum.

The metal mesh may include at least one hole 330h. A diameter D1 of the hole 330h may be designed taking into account the wavelength of microwaves radiated from the antenna 320. For example, the diameter D1 of the hole 330h may be equal to or less than ½ of the wavelength of the microwaves radiated from the antenna 320. For example, the diameter D1 of the hole 330h may be equal to or less than ¼ of the wavelength of the microwaves radiated from the antenna 320.

The shielding portion 330 may have a rectangular shape having a length L2 and a width W2. The shielding portion 330 may be rectangular in shape in a flat unfolded state. The length L2 of the shielding portion 330 may be defined as a distance between one end 331 and the other end 332 of the shielding portion 330 in one direction (e.g., an x direction) in the state in which the shielding portion 330 is unfolded. The width W2 of the shielding portion 330 may be defined as a distance between one end 333 and the other end 334 of the shielding portion 330 in a direction perpendicular to the one direction (e.g., a z direction) in the state in which the shielding portion 330 is unfolded.

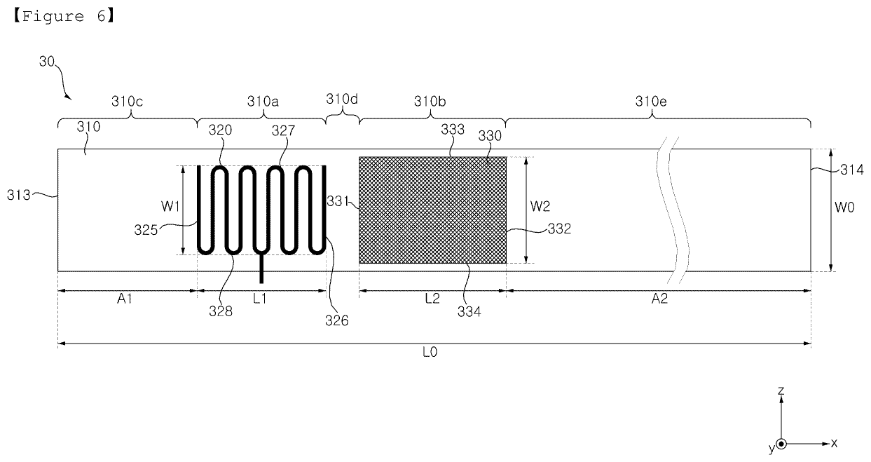

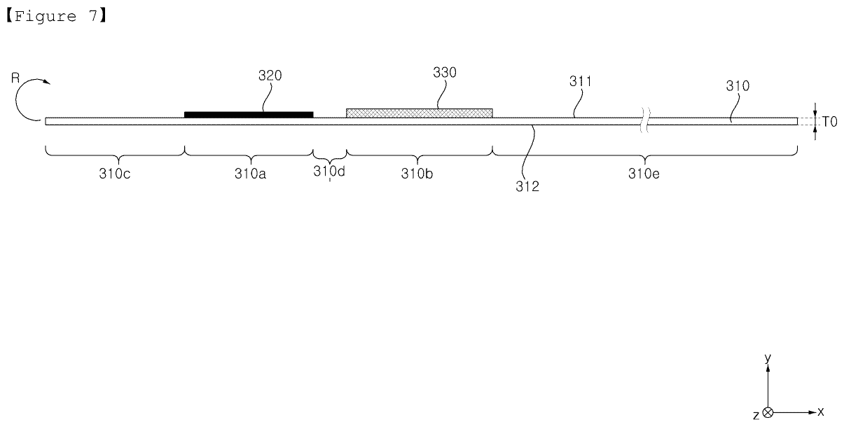

FIG. 6 is a view showing an unfolded state of the radiating unit according to the embodiment of the present disclosure when viewed from above, and FIG. 7 is a view showing the unfolded state of the radiating unit according to the embodiment of the present disclosure when viewed from the side.

Referring to FIGS. 6 and 7, the sheet 310 may extend in one direction (e.g., in the x direction). The antenna 320 and the shielding portion 330 may be attached to the sheet 310. The antenna 320 and the shielding portion 330 may be curled in the longitudinal direction of the sheet 310 together with the sheet 310. The sheet 310 may form a plurality of layers in the hollow radiating unit 30. The sheet 310 may form at least one layer surrounding the antenna 320 outside the antenna 320 and at least one layer surrounding the shielding portion 330 outside the shielding portion 330.

The sheet 310, which is a flexible sheet, may be made of a heat-resistant material. The sheet 310 may include, but is not limited to, polyimide or polyetheretherketone (PEEK), and may include other materials that are elastic, heat resistant, and electrically insulative.

The antenna 320 and the shielding portion 330 may be sequentially disposed in the longitudinal direction of the sheet 310. The antenna 320 and the shielding portion 330 may be disposed spaced apart from each other in the longitudinal direction of the sheet 310.

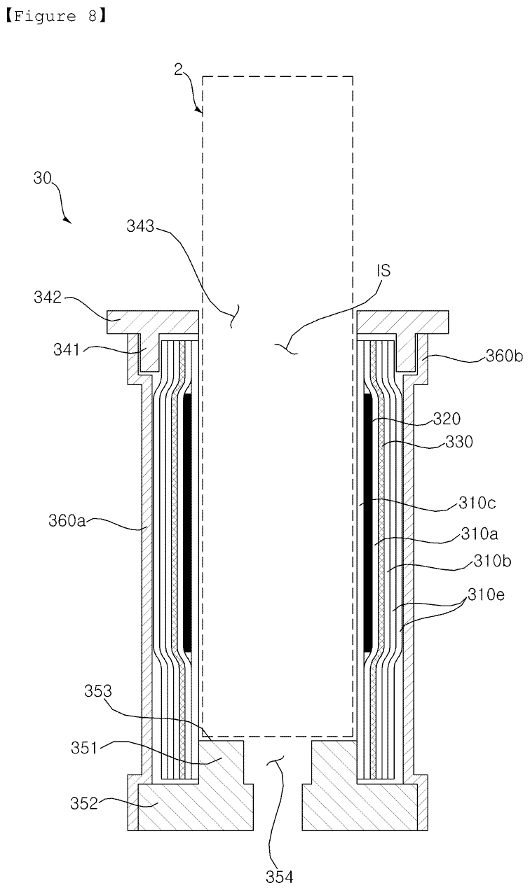

The antenna 320 and the shielding portion 330 may be disposed on the same surface of the sheet 310. The sheet 310 may be a single sheet extending in one direction (e.g., in the x direction). The sheet 310 may include a flat first surface 311 and a second surface 312 that forms an opposite surface to the first surface 311 in the thickness direction. The antenna 320 and the shielding portion 330 may be disposed on the first surface 311. The sheet 310 may be curled such that the first surface 311 faces the inside or the insertion space IS of the hollow radiating unit 30 (see FIG. 8). The radiating unit 30 may be formed by curling the antenna 320 and the shielding portion 330 together with the sheet 310.

The sheet 310 may include first to fifth parts 310a, 310b, 310c, 310d, and 310e. The antenna 320 may be disposed in the first part 310a. The shielding portion 330 may be disposed in the second part 310b. The third part 310c may be disposed on the left side of the first part 310a in the longitudinal direction of the sheet 40 and may be connected to the first part 310a. The fourth part 310d may be disposed between the first part 310a and the second part 310b and may be connected to the first part 310a and the second part 310b. The fifth part 310e may extend from the second part 310b in the longitudinal direction of the sheet 310 and may face the fourth part 310d with the second part 310b interposed therebetween. The sheet 310 may be curled in a direction from one end 313 of the first part 310a toward one end 314 of the fifth part 310e.

The antenna 320 may be disposed spaced apart from one end 313 of the sheet 310 in the longitudinal direction of the sheet 310. In the longitudinal direction of the sheet 310, one end 325 of the antenna 320 may be disposed spaced apart from one end 313 of the sheet 310 by a first distance A1. In other words, one end 325 of the antenna 320 and one end 313 of the sheet 310 may be spaced apart from each other by a length A1 of the third part 310c of the sheet 310.

The length L1 of the antenna 320, defined in the longitudinal direction of the sheet 310, may be less than or equal to the first distance A1. Due to the structural features thereof, in the hollow radiating unit 30, the third part 310c of the sheet 310 may surround the inside of the antenna 320 and may prevent the antenna 320 from being exposed to the insertion space IS.

The shielding portion 330 may be disposed spaced apart from the antenna 320 in the longitudinal direction of the sheet 310. In the longitudinal direction of the sheet 310, one end 331 of the shielding portion 330 may be disposed spaced apart from the other end 326 of the antenna 320 by a predetermined distance.

A width W0 of the sheet 310 may be greater than the width W1 of the antenna 320 and the width W2 of the shielding portion 330. The antenna 320 and the shielding portion 330 may be disposed spaced apart from both ends of the sheet 310 in the width direction (e.g., the z direction) of the sheet 310.

The width W2 of the shielding portion 330, defined in the width direction of the sheet 310, may be greater than or equal to the width W1 of the antenna 320. In the width direction of the sheet 310, one end or an upper end 333 of the shielding portion 330 may be disposed closer to one end or an upper end of the sheet 310 than one end or an upper end 327 of the antenna 320. In the width direction of the sheet 310, the other end or a lower end 334 of the shielding portion 330 may be disposed closer to the other end or a lower end of the sheet 310 than the other end or a lower end 328 of the antenna 320.

The length L2 of the shielding portion 330, defined in the longitudinal direction of the sheet 310, may be longer than the length L1 of the antenna 320.

In the hollow radiating unit 30, the shielding portion 330 may surround the antenna 320 on the outside of the antenna 320. Through a structure in which the width W2 of the shielding portion 330 is greater than or equal to the width W1 of the antenna 320 and/or the length L2 of the shielding portion 330 is longer than the length L1 of the antenna 320, the shielding portion 330 may surround the entire outer side or outer surface of the antenna 320 without exposure of any portion of the outer side or outer surface of the antenna 320 to the outside.

The antenna 320 and the shielding portion 330 may be attached to the sheet 310 by thermal fusion. The antenna 320 and the shielding portion 330 are respectively disposed on the first surface 311 of the first part 310a and the first surface 311 of the second part 310b of the sheet 310, and the sheet 310, the antenna 320, and the shielding portion 330 are heated to a predetermined temperature or higher, thereby attaching the antenna 320 and the shielding portion 330 to the sheet 310.

Accordingly, the bonding structure of the radiating unit 30 may be simplified.

Meanwhile, although not shown in the drawing, the antenna 320 and the shielding portion 330 may be disposed on different surfaces of the sheet 310. For example, the antenna 320 may be disposed on the first surface 311 of the sheet 310, and the shielding portion 330 may be disposed on the second surface 312 of the sheet 310. The antenna 320 and the shielding portion 330 may be disposed spaced apart from one end 313 of the sheet 310 in the longitudinal direction of the sheet 310. In the longitudinal direction of the sheet 310, one end 325 of the antenna 320 may be disposed spaced apart from one end 313 of the sheet 310 by the first distance A1. The length L1 of the antenna 320, defined in the longitudinal direction of the sheet 310, may be less than or equal to the first distance A1. The sheet 310 may be curled such that the first surface 311 faces the inside or the insertion space IS of the hollow radiating unit 30.

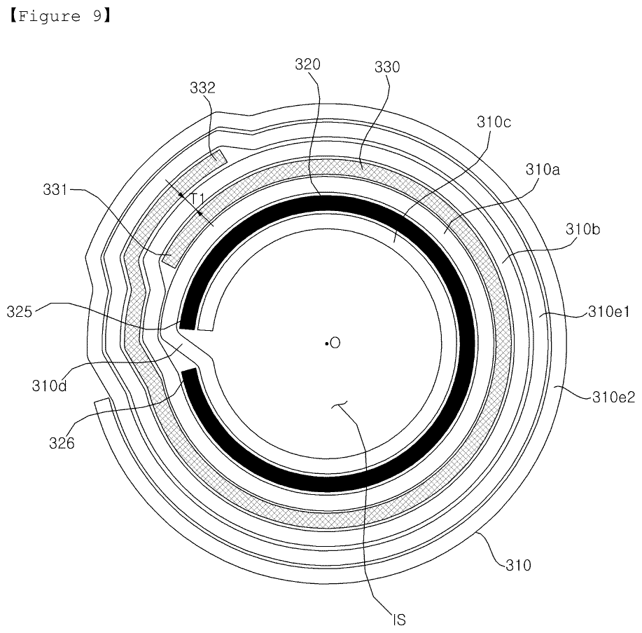

FIG. 8 is a sectional view of the radiating unit according to the embodiment of the present disclosure when viewed from the side, and FIG. 9 is a sectional view of the radiating unit according to the embodiment of the present disclosure viewed from above.

Referring to FIG. 8, in the hollow radiating unit 30, the insertion space IS may be disposed inside the antenna 320. At least one layer 310c may be disposed inside the antenna 32. The layer may be referred to as a protective layer. The protective layer 310c disposed inside the antenna 320 may surround the inside of the antenna 320. In other words, the third part 310c of the sheet 310 may surround the inside of the antenna 320. The protective layer 310c disposed inside the antenna 320 may prevent at least a part of the inner surface of the antenna 320 from being exposed to the insertion space IS.

The protective layer 310c may surround the insertion space IS. The inner surface of the antenna 320 may face the aerosol-generating article 2 inserted into the insertion space IS. At least a part of the protective layer 310c may come into contact with the outer circumferential surface of the aerosol-generating article 2 inserted into the insertion space IS.

Accordingly, at least one protective layer 310c surrounding the inside of the antenna 320 is disposed inside the antenna 320 such that the antenna 320 is prevented from being damaged during the insertion and removal process of the aerosol-generating article 2.

In the width direction of the sheet 310 or the longitudinal direction of the radiating unit 30, the antenna 320 and the shielding portion 330 may be spaced apart from the upper end and the lower end of the sheet 310. In the hollow radiating unit 30, the upper and lower ends of the third part 310c and the upper and lower ends of the first part 310a are in contact with each other. The antenna 320 may be sealed from the outside by a structure in which the upper ends and the lower ends of the third part 310c and the first part 310a are in contact with each other and the sheet 310 is curled.

The brackets 340 and 350 may be connected to one end and the other end of the hollow radiating unit 30, respectively. The brackets 340 and 350 may include a first bracket 340 attached or coupled to one end of the radiating unit 30, which corresponds to the opening of the insertion space IS, and a second bracket 350 attached or coupled to the other end of the radiating unit 30.

The first bracket 340 may have an overall cylindrical shape and may have a flange 342 protruding from the upper end thereof in a radially outward direction. The lower side of a first bracket body 341 may be attached to or press-fit into one end of the radiating unit 30. The first bracket 340 may have an insertion opening 343 formed to pass through a central part thereof upward and downward. One side of the flange 342 may be recessed in a radially inward direction to form an alignment groove. The alignment groove may have a shape corresponding to a protrusion provided on the body 11.

The alignment groove may be coupled to the protrusion provided on the body 11. The alignment groove may prevent rotation of the radiating unit 30 in the body 11, and the radiating unit 30 may be stably coupled to the body 11 by the alignment groove.

The second bracket 350 may have an overall cylindrical shape and may have a flange 352 protruding from the lower end thereof in a radially outward direction. The upper side of a second bracket body 351 may be attached to or press-fit into the other end of the radiating unit 30. The second bracket 350 may have a hole 354 formed to pass through a central part thereof upward and downward.

The insertion opening 343 in the first bracket 340 may communicate with one side, which is open, of the insertion space IS. The hole 354 in the second bracket 350 may communicate with the other side of the insertion space IS. The aerosol-generating article 2 may be inserted into the insertion space IS through the insertion opening 343. Through the hole 354, outside air may be introduced into the inside of the aerosol-generating article 2 from the outside of the radiating unit 30 via the end of the aerosol-generating article 2. An inner circumferential surface of the first bracket body 341 may support at least a part of the outer circumferential surface of the aerosol-generating article 2 inserted into the insertion space IS. An upper surface 353 of the second bracket body 351 may support at least a part of the lower end of the aerosol-generating article 2 inserted into the insertion space IS.

Accordingly, both ends of the radiating unit 30 including the antenna 320 and the shielding portion 330 may be stably fixed, thereby ensuring rigidity of the radiating unit 30.

The brackets 340 and 350 may be made of, but are not limited to, stainless steel, aluminum, polyetheretherketone (PEEK), or an alloy.

Referring to FIG. 9 together with FIG. 8, the radiating unit 30 may have layers thereof formed in the order of the third part 310c of the sheet 310, the antenna 320, the first part 310a and/or the fourth part 310d of the sheet 310, the shielding portion 330, the second part 310b of the sheet 310, and the fifth part 310e of the sheet 310 in the radially outward direction from the insertion space IS.

At least a part of the sheet 310 may be disposed between the antenna 320 and the shielding portion 330 in the radial direction of the radiating unit 30 or the radial direction of the insertion space IS, and may form at least one layer between the antenna 320 and the shielding portion 330. For example, the fourth part 310d of the sheet 310 may be in contact with the antenna 320 and may surround the outside of the antenna 320. The fourth part 310d may be in contact with the shielding portion 330, and the shielding portion 330 may surround the outside of the fourth part 310d. The corresponding layer may be referred to as an insulating layer.

Accordingly, the antenna 320 and the shielding portion 330 may be prevented from being electrically shorted.

The shielding portion 330 may surround the outside of the antenna 320 by at least one turn in the circumferential direction of the radiating unit 30 or the circumferential direction of the insertion space IS. The length L2 of the shielding portion 330, defined in the longitudinal direction of the sheet 310, may be longer than the length L1 of the antenna 320. In the radial direction of the radiating unit 30, one end 331 of the shielding portion 330 and a portion adjacent to the one end 331 may overlap the other end 332 of the shielding portion 330 and a portion adjacent to the other end 332.

In the radial direction of the radiating unit 30, at least one layer formed by the sheet 310 may be disposed between the one end 331 and the other end 332 of the shielding portion 330. A total thickness Ti of the layer disposed between the one end 331 and the other end 332 of the shielding portion 330 may be an integer multiple of a thickness TO of the sheet 310. The total thickness Ti of the layer disposed between the one end 331 and the other end 332 of the shielding portion 330 may be equal to or less than ½ of the wavelength of the microwaves. Alternatively, the total thickness Ti of the layer disposed between the one end 331 and the other end 332 of the shielding portion 330 may be equal to or less than ¼ of the wavelength of the microwaves radiated from the antenna 320.

At least a part of the sheet 310 may be disposed outside the shielding portion 330 in the radial direction of the radiating unit 30 and may form at least one layer surrounding the outside of the shielding portion 330. The second part 310b of the sheet 310 may be in contact with the shielding portion 330 and may surround the outside of the shielding portion 330. The fifth part 310e of the sheet 310 may surround the outside of the second part 310b. The corresponding layer may be referred to as an insulating layer.

In the radial direction of the radiating unit 30, the number of layers surrounding the outside of the shielding portion 330 may be greater than the number of layers disposed inside the antenna 320. For example, 1 to 2 layers may be disposed inside the antenna 320, and 2 to 4 layers may be disposed outside the shielding portion 330.

In this manner, through a structure in which the outside of the shielding portion 330 is surrounded by the sheet 310 a plurality of times, heat dissipation to the outside of the radiating unit 30 may be maximally reduced.

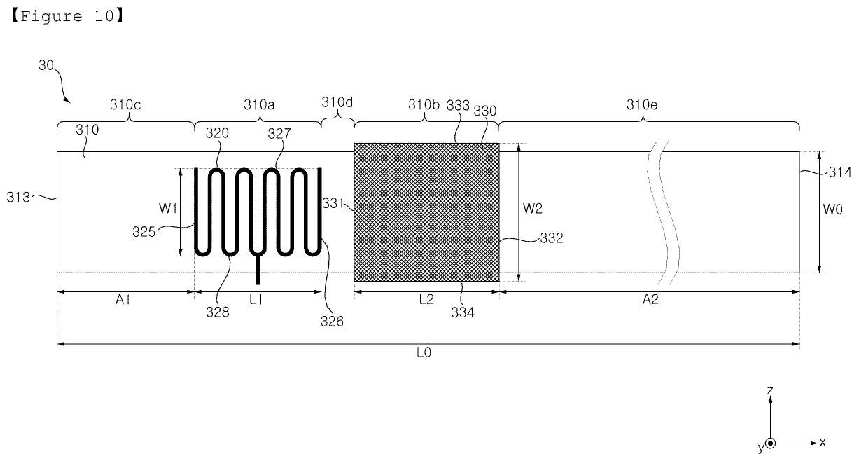

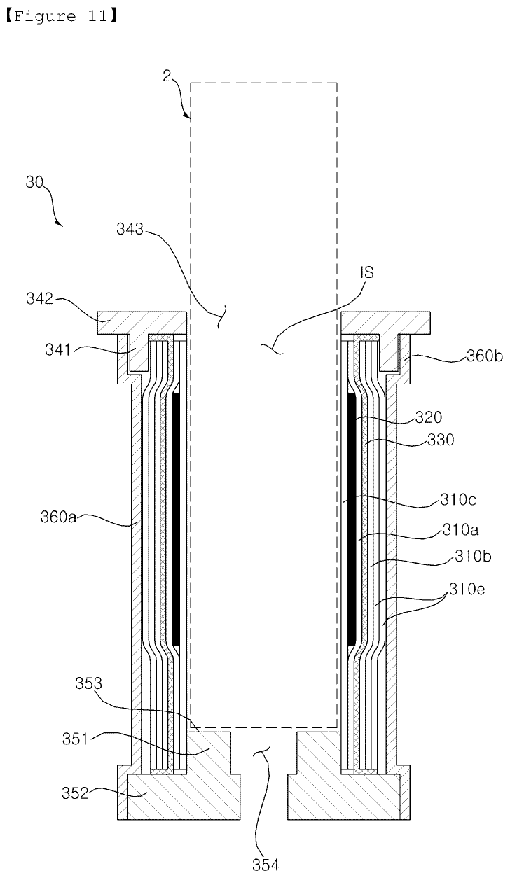

FIG. 10 is a view showing the unfolded state of the radiating unit according to the embodiment of the present disclosure, and FIG. 11 is a sectional view of the radiating unit according to the embodiment of the present disclosure when viewed from the side. Among the features shown in FIGS. 10 and 11, a detailed description of the features overlapping the features shown in FIGS. 6 to 9 will be omitted.

Referring to FIG. 10, the sheet 310 may extend in one direction (e.g., in the x direction). The antenna 320 and the shielding portion 330 may be attached to the sheet 310. The antenna 320 and the shielding portion 330 may be curled in the longitudinal direction of the sheet 310 together with the sheet 310. The sheet 310 may form a plurality of layers in the hollow radiating unit 30. The sheet 310 may form at least one layer surrounding the antenna 320 on the outside of the antenna 320 and at least one layer surrounding the shielding portion 330 on the outside of the shielding portion 330.

The shielding portion 330 may be disposed spaced apart from the antenna 320 in the longitudinal direction of the sheet 310. In the longitudinal direction of the sheet 310, one end 331 of the shielding portion 330 may be disposed spaced apart from the other end 326 of the antenna 320 by a predetermined distance.

The width W0 of the sheet 310 may be greater than the width W1 of the antenna 320. The antenna 320 may be disposed spaced apart from both ends of the sheet 310 in the width direction of the sheet 310.

The width W2 of the shielding portion 330, defined in the width direction of the sheet 310, may be greater than or equal to the width W0 of the sheet 310. In the width direction of the sheet 310, one end or the upper end 333 of the shielding portion 330 may be aligned with one end or the upper end of the sheet 310 or may be disposed outside the sheet 310. In the width direction of the sheet 310, the other end or the lower end 334 of the shielding portion 330 may be aligned with the other end or the lower end of the sheet 310 or may be disposed outside the sheet 310.

Referring to FIG. 11, the antenna 320 may be spaced apart from the upper and lower ends of the sheet 310. In the hollow radiating unit 30, the upper and lower ends of the third part 310c and the upper and lower ends of the first part 310a are in contact with each other. The antenna 320 may be sealed from the outside by a structure in which the upper and lower ends of the third part 310c and the upper and lower ends of the first part 310a are in contact with each other and the sheet 310 is curled into a round shape.

The upper and lower ends of the shielding portion 330 may be aligned with the upper and lower ends of the sheet 310, or the shielding portion 330 may protrude from the upper and/or lower ends of the sheet 310 to the outside of the sheet 310. A protruding portion of the shielding portion 330 may be in electrical contact with at least one of the first bracket 340 and the second bracket 350.

At least one of the first bracket 340 and the second bracket 350 may include a metal component. At least one of the first bracket 340 and the second bracket 350 may be in electrical contact with the shielding portion 330 in the longitudinal direction of the radiating unit 30.

Accordingly, rigidity of the radiating unit 30 is secured by the first bracket 340 and the second bracket 350, and simultaneously, the microwaves radiated from the antenna 320 may be prevented from being emitted out of the radiating unit 30 through the insertion space IS and/or the brackets 340 and 350.

As described above, in accordance with at least one of embodiments of the present disclosure, there is provided a radiating unit formed by curling a thin film antenna and a shielding portion disposed on a sheet together with the sheet, whereby it is possible to reduce the size or volume of the radiating unit.

In accordance with at least one of the embodiments of the present disclosure, the shielding portion surrounds the outside of the antenna, and at least one insulating layer is disposed between the shielding portion and the antenna, whereby it is possible to prevent electrical contact between the shielding portion and the antenna and to prevent microwaves radiated from the antenna from being emitted out of the radiating unit.

In accordance with at least one of the embodiments of the present disclosure, at least one protective layer surrounding the inside of the antenna is disposed inside the antenna, whereby it is possible to prevent the antenna from being damaged during the insertion and removal of an aerosol-generating article.

In accordance with at least one of the embodiments of the present disclosure, there is provided a structure in which a sheet surrounds the outside of the shielding portion a plurality of times, whereby it is possible to maximally reduce heat dissipation to the outside of the radiating unit.

In accordance with at least one of the embodiments of the present disclosure, there are provided brackets configured to respectively fix the upper end and the lower end of the radiating unit and connected to the shielding portion, whereby it is possible to secure rigidity of the radiating unit and to prevent microwaves from being emitted out of the radiating unit through the insertion space.

Referring to FIGS. 1 to 11, the aerosol-generating device 1 includes a body 11 and a radiating unit 30 disposed in the body 11 and formed to provide an insertion space IS accommodating an aerosol-generating article 2 therein, wherein the radiating unit includes a sheet 310 elongated in a longitudinal direction, an antenna 320 surrounding the insertion space IS, the antenna being configured to emit microwaves for dielectrically heating the aerosol-generating article 2, and a shielding portion 330 surrounding the antenna 320, the shielding portion being configured to prevent the microwaves from being emitted out of the radiating unit 30, and wherein the radiating unit 30 is configured such that the antenna 320 and the shielding portion 330 are disposed spaced apart from each other on the sheet 310 in the longitudinal direction of the sheet 310 and the sheet 310 is rolled in the longitudinal direction.

In accordance with another aspect of the present disclosure, the shielding portion 330 may be a metal sheet or a metal mesh.

In accordance with another aspect of the present disclosure, the metal mesh may include at least one hole 330h, and a diameter of the hole 330h may be less than ½ of a wavelength of the microwaves.

In accordance with another aspect of the present disclosure, a width of the shielding portion 330, defined in a width direction intersecting with the longitudinal direction of the sheet 310, may be greater than or equal to a width of the antenna 320, and in the width direction of the sheet 310, an upper end of the shielding portion 330 may be disposed higher than an upper end of the antenna 320, and a lower end of the shielding portion 330 may be disposed lower than a lower end of the antenna 320.

In accordance with another aspect of the present disclosure, a length L2 of the shielding portion 330, defined in the longitudinal direction of the sheet 310, may be longer than a length L1 of the antenna 320.

In accordance with another aspect of the present disclosure, the shielding portion 330 may surround an outside of the antenna 320 by at least one turn in a circumferential direction of the radiating unit 30.

In accordance with another aspect of the present disclosure, the shielding portion 330 may be disposed outside the antenna 320 in a radial direction of the radiating unit 30, and at least one layer formed by the sheet 310 may be disposed between the antenna 320 and the shielding portion 330 in the radial direction of the radiating unit 30.

In accordance with another aspect of the present disclosure, the antenna 320 may have one end 325 disposed spaced apart from one end 313 of the sheet 310 by a first distance A1 in the longitudinal direction of the sheet 310, and the length L1 of the antenna 320, defined in the longitudinal direction of the sheet 310, may be less than or equal to the first distance A1.

In accordance with another aspect of the present disclosure, the radiating unit 30 may have at least one layer formed by the sheet 310 and disposed inside the antenna 320 in a radial direction of the radiating unit 30.

In accordance with another aspect of the present disclosure, the radiating unit 30 may have a plurality of layers formed by the sheet 310 and disposed outside the shielding portion 330 in the radial direction of the radiating unit 30, and the number of layers disposed outside the shielding portion 330 may be greater than the number of layers disposed inside the antenna 320.

In accordance with another aspect of the present disclosure, the aerosol-generating device may further include a first bracket 340 coupled to one side of the radiating unit 30 corresponding to an opening of the insertion space IS, the first bracket having an insertion opening in communication with the insertion space IS, and a second bracket 350 coupled to the other side of the radiating unit 30 and blocking a portion of the other side of the insertion space IS.

In accordance with another aspect of the present disclosure, at least one of the first bracket 340 and the second bracket 350 may include a metal component and may contact the shielding portion 330 in a longitudinal direction of the insertion space IS.

In accordance with another aspect of the present disclosure, the sheet 310 may include polyimide.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a body; and
a radiating unit disposed in the body and formed to provide an insertion space accommodating an aerosol-generating article therein,
wherein the radiating unit comprises:
a sheet elongated in a longitudinal direction;
an antenna surrounding the insertion space, the antenna being configured to emit microwaves for dielectrically heating the aerosol-generating article; and
a shielding portion surrounding the antenna, the shielding portion being configured to prevent the microwaves from being emitted out of the radiating unit, and
wherein the radiating unit is configured such that the antenna and the shielding portion are disposed spaced apart from each other on the sheet in the longitudinal direction of the sheet and the sheet is rolled in the longitudinal direction.

2. The aerosol-generating device according to claim 1, wherein the shielding portion is a metal sheet or a metal mesh.

3. The aerosol-generating device according to claim 2, wherein
the metal mesh comprises at least one hole, and
a diameter of the hole is less than ½ of a wavelength of the microwaves.

4. The aerosol-generating device according to claim 1, wherein
a width of the shielding portion, defined in a width direction intersecting with the longitudinal direction of the sheet, is greater than or equal to a width of the antenna, and
in the width direction of the sheet, an upper end of the shielding portion is disposed higher than an upper end of the antenna, and a lower end of the shielding portion is disposed lower than a lower end of the antenna.

5. The aerosol-generating device according to claim 1, wherein a length of the shielding portion, defined in the longitudinal direction of the sheet, is longer than a length of the antenna.

6. The aerosol-generating device according to claim 1, wherein the shielding portion surrounds an outside of the antenna by at least one turn in a circumferential direction of the radiating unit.

7. The aerosol-generating device according to claim 1, wherein
the shielding portion is disposed outside the antenna in a radial direction of the radiating unit, and
at least one layer formed by the sheet is disposed between the antenna and the shielding portion in the radial direction of the radiating unit.

8. The aerosol-generating device according to claim 1, wherein
the antenna has one end disposed spaced apart from one end of the sheet by a first distance in the longitudinal direction of the sheet, and
a length of the antenna, defined in the longitudinal direction of the sheet, is less than or equal to the first distance.

9. The aerosol-generating device according to claim 1, wherein the radiating unit comprises at least one layer formed by the sheet and disposed inside the antenna in a radial direction of the radiating unit.

10. The aerosol-generating device according to claim 9, wherein
the radiating unit comprises a plurality of layers formed by the sheet and disposed outside the shielding portion in the radial direction of the radiating unit, and
a number of the layers disposed outside the shielding portion is greater than a number of the layers disposed inside the antenna.

11. The aerosol-generating device according to claim 1, further comprising:
a first bracket coupled to one side of the radiating unit corresponding to an opening of the insertion space, the first bracket having an insertion opening in communication with the insertion space; and
a second bracket coupled to the other side of the radiating unit, the second bracket blocking a portion of the other side of the insertion space.

12. The aerosol-generating device according to claim 11, wherein at least one of the first bracket and the second bracket comprises a metal component and contacts the shielding portion in a longitudinal direction of the insertion space.

13. The aerosol-generating device according to claim 1, wherein the sheet comprises polyimide.
